(19) United States
(12) Patent Application Publication
(10) Pub. No.: US 2015/0095222 A1
(43) Pub. Date: Apr. 2, 2015

(54) DYNAMIC IDENTITY REPRESENTATION IN MOBILE DEVICES

(71) Applicant: Tyfone, Inc., Portland, OR (US)

(72) Inventor: Siva G. Narendra, Portland, OR (US)

(21) Appl. No.: 14/044,636

(22) Filed: Oct. 2, 2013

(51) Int. Cl. G06Q 20/32

(52) U.S. Cl. CPC G06Q 20/3278; G06Q 20/3227
USPC 705/41

(57) ABSTRACT

A mobile device includes a memory device, a display device, and processor coupled to a secure element. The secure element is configured to provide identity data that includes both static data and dynamic data. The memory device includes a plurality of applications and is coupled to the processor. When an application in the memory device is executed it causes the processor to request identity data from secure element in order to provide a representation of the identity data via the mobile device.

### FIELD

The present invention relates generally to mobile devices, and more specifically to identity representation in mobile devices.

### BACKGROUND

Mobile devices such as smartphones are being employed for ever-increasing numbers of applications beyond voice communications. For example, modern mobile devices may include near field communications (NFC) radios capable of communicating with external devices such as point of sale (POS) terminals to effect payment transactions.

### BRIEF DESCRIPTION OF THE DRAWINGS

FIG. 1 shows a mobile device displaying a mobile wallet screen in accordance with various embodiments of the present invention;

FIG. 2 shows a mobile device displaying an authentication screen in accordance with various embodiments of the present invention;

FIGS. 3 and 4 show mobile devices providing dynamic identity representations in accordance with various embodiments of the present invention;

FIG. 5 shows a block diagram of a mobile device in accordance with various embodiments of the present invention;

FIG. 6 shows a block diagram of a mobile device and a token in accordance with various embodiments of the present invention;

FIG. 7 shows interactions between a processor, a secure element, and a display device in accordance with various embodiments of the present invention;

FIG. 8 shows interactions between a processor, a secure element, and a speaker in accordance with various embodiments of the present invention;

FIG. 9 shows a secure element in accordance with various embodiments of the present invention;

FIGS. 10 and 11 show interface communications with a secure element in accordance with various embodiments of the present invention;

FIG. 12 shows a barcode reader interacting with a dynamic identity representation in accordance with various embodiments of the present invention;

FIG. 13 shows a mobile device camera interacting with a dynamic identity representation in accordance with various embodiments of the present invention;

FIG. 14 shows a mobile device microphone interacting with a dynamic identity representation in accordance with various embodiments of the present invention;

FIG. 15 shows a mobile device with a secure element on a circuit board in accordance with various embodiments of the present invention;

FIG. 16 shows a mobile device with a secure element in a semiconductor chip in accordance with various embodiments of the present invention;

FIG. 17 shows a mobile device with a secure element on a subscriber identity module (SIM) card in accordance with various embodiments of the present invention;

FIG. 18 shows a mobile device with a memory card that includes a secure element in accordance with various embodiments of the present invention;

FIG. 19 shows a mobile device with a connector that includes a secure element in accordance with various embodiments of the present invention;

FIG. 20 shows a mobile device with a token that includes a secure element in accordance with various embodiments of the present invention; and

FIG. 21 shows a flowchart of methods in accordance with various embodiments of the present invention.

### DESCRIPTION OF EMBODIMENTS

In the following detailed description, reference is made to the accompanying drawings that show, by way of illustration, various embodiments of an invention. These embodiments are described in sufficient detail to enable those skilled in the art to practice the invention. It is to be understood that the various embodiments of the invention, although different, are not necessarily mutually exclusive. For example, a particular feature, structure, or characteristic described in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

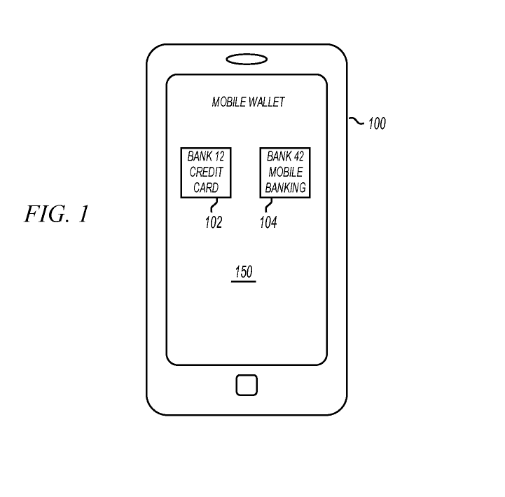

FIG. 1 shows a mobile device displaying a mobile wallet screen in accordance with various embodiments of the present invention. Mobile device 100 includes display device 150 that is shown displaying a mobile wallet screen. The mobile wallet screen is in turn shown displaying icons for two applications: “Bank 12 Credit Card” 102; and “Bank 42 Mobile Banking” 104. In the example mobile wallet screen of FIG. 1, a user may launch either of the two applications by interacting with the associated icon. For example, a user might tap on icon 102 to launch mobile payment application “Bank 12 Credit Card” or icon 104 to launch mobile banking application “Bank 42 Mobile Banking ” In some embodiments, applications such as “Bank 12 Credit Card” 102 and “Bank 42 Mobile Banking” 104 cause identity data representing a user of the mobile device to be displayed as a visual indication on display device 150. These and other embodiments are more fully described below with reference to later figures.

Although the various embodiments of the present invention are described with reference to financial applications, this is not a limitation of the present invention. For example, any application that utilizes identity data may be substituted without departing from the scope of the present invention. Some embodiments may include access control applications, financial applications, security applications, and the like.

Mobile device 100 may be any mobile device that includes a display device capable of displaying a visual indication of identity data. Examples include, but are not limited to, mobile phones, tablet computers, personal digital assistants, and the like.

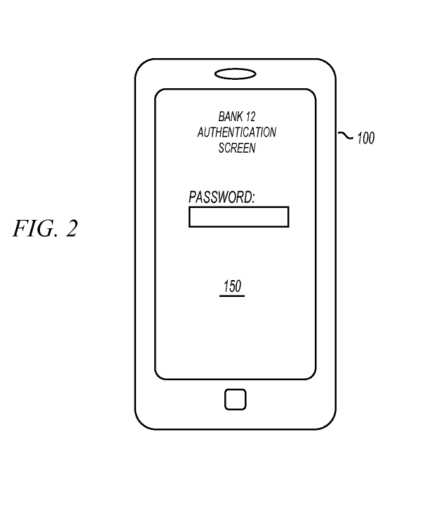

FIG. 2 shows a mobile device displaying an authentication screen in accordance with various embodiments of the present invention. The authentication screen shown in FIG. 2, or some other authentication screen, may be displayed when a user interacts with icon 102 (FIG. 1). For example, when a user launches the “Bank 12 Credit Card” application, the user may be presented with the screen shown in FIG. 2 to authenticate using a password. In some embodiments, the password entered by the user is validated using software within mobile device 100, and in other embodiments, the password is validated using hardware within, or coupled to, mobile device 100. For example, the password may be routed to a smartcard secure element for validation. The smartcard secure element may be in any location, including within mobile device 100, on a card in an add-on slot of mobile device 100, or in communications with mobile device 100 over a contact or contactless interface. Cards in add-on slots may or may not be removable. For example, a memory card may be user accessible and removable, or may be embedded deep within the mobile device to provide system memory, and nonremovable. Smartcard secure elements and their various possible locations are described more fully below. In some embodiments, passwords may be alphanumeric only, and in other embodiments, passwords may be numeric only and yet in others they may include special characters.

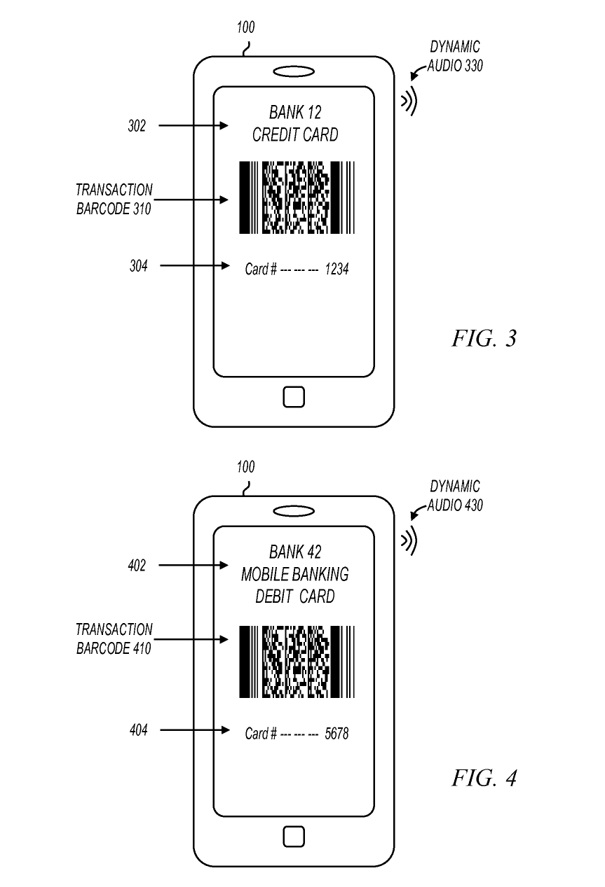

FIGS. 3 and 4 show mobile devices providing dynamic identity representations in accordance with various embodiments of the present invention. FIG. 3 shows mobile device 100 displaying a screen shot of the Bank 12 Credit Card application. In some embodiments, this screen may be displayed after a user successfully authenticates to the mobile device or the application as described above with reference to FIG. 2. The Bank 12 Credit Card application is an example of a mobile payment application that allows a user to make credit card payments using a credit card issued by Bank 12.

As shown in FIG. 3, the mobile payment application may display information specific to an application provider (e.g., branding information 302), and information specific to a user (e.g., transaction barcode 310 and/or credit card number 304). Transaction barcode 310 represents a visual indication of identity data useful for a transaction. In financial application embodiments represented by FIG. 3, the identity data represents a payment identity, such as a credit card transaction authorization. A different transaction barcode 310 may be displayed each time a transaction is authorized.

In some embodiments, transaction barcode 310 represents identity data that includes static data and dynamic data. The static data includes data that does not change from one transaction to the next. Examples of static data may include data that describes the mobile device user or a payment instrument, such as a name, a credit card number, credit card track data, or the like. The dynamic data includes data that does change from one transaction to the next. Examples of dynamic data include dynamic card security codes (CSC) such as dynamic Card Verification Values (CVV or CVV2), dynamic Card Verification Value Codes (CVVC), dynamic Card Verification Code (CVC), or dynamic Card Code Verification (CCV). The foregoing list of dynamic card security codes represents examples of dynamic data and the list is not meant to be exhaustive.

FIG. 3 also shows dynamic audio 330. In some embodiments, dynamic audio 330 represents identity data that includes static data and dynamic data. The static data includes data that does not change from one transaction to the next. Examples of static data may include data that describes the mobile device user or a payment instrument, such as a name, a credit card number, credit card track data, or the like. The dynamic data includes data that does change from one transaction to the next. Examples of dynamic data are listed in the previous paragraph.

FIG. 3 displays various representations of identity data that each include static data and dynamic data. The identity data may be used for any purpose. For example, in some embodiments, the identity data may be used to indicate authorization of a payment by a user. Some embodiments present identity data only as a visual indication (e.g., transaction barcode 310), and other embodiments present identity data only as an audio indication (e.g., dynamic audio 330). Still further embodiments present identity data using a combination of indications (e.g., both visual and audio indications). The presentation of identity data with both static and dynamic information is not limited to visual and audio indications as shown in FIG. 3. Any number of different types of devices may be used to present indications of identity data. For example, identity data that includes both static and dynamic data may be represented by audio, video, radio waves, or the like.

FIG. 4 shows mobile device 100 displaying a screen shot of the financial application: Bank 42 Mobile Banking This application is launched from mobile wallet screen 150 (FIG. 1) by tapping icon 104. The Bank 42 Mobile Banking application is an example of a mobile banking application that allows a user to access banking functions provided by Bank 42.

As shown in FIG. 4, the mobile banking application may display information specific to an application provider (e.g., branding information 402), and information specific to a user (e.g., debit card number 404). FIG. 4 displays various representations of static and dynamic data used to indicate authorization for use of mobile banking application. A mobile banking application may be an application that communicates with a banking service to allow a user to perform banking functions such as balance inquiries, funds transfers, bill payment and the like. FIG. 4 includes transaction barcode 410, and dynamic audio 430 which include both static and dynamic information as authorization for a banking function being made by the user. FIG. 4 shows both transaction barcode 410 and dynamic audio 430; however this is not to be taken in a limiting sense. In other embodiments, the static and dynamic information may be represented by a plurality of devices. For example, data that includes both static and dynamic data may be represented by audio, video, radio waves, or the like.

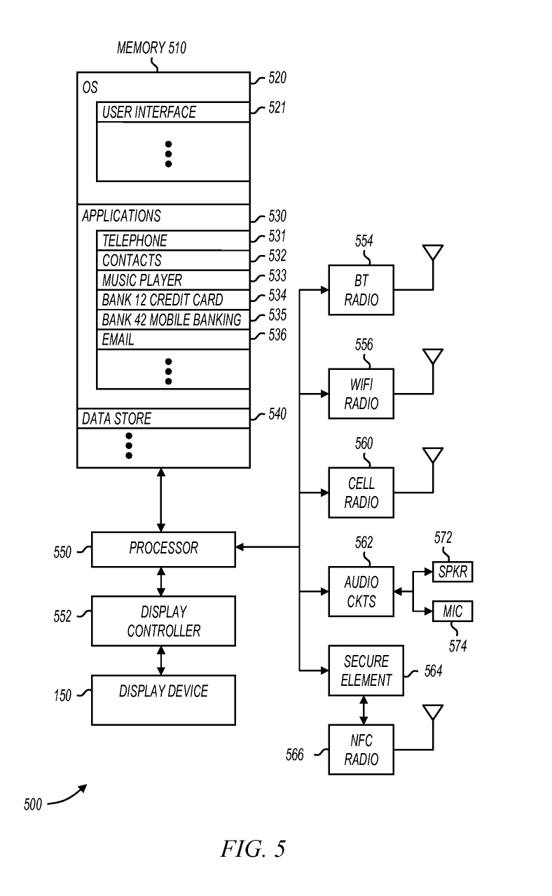

FIG. 5 shows a block diagram of a mobile device in accordance with various embodiments of the present invention. Mobile device 500 includes processor 550, memory 510, display controller 552, display device 150, cellular radio 560, audio circuits 562, Bluetooth radio 554, Wi-Fi radio 556, secure element 564, and near field communications (NFC) radio 566. Mobile device 500 represents any type of mobile device capable of performing as described herein, including any of mobile devices 100 (FIGS. 1-4). For example, in some embodiments, mobile device 500 may be a cell phone, a smartphone, a tablet computer, a laptop computer, or the like.

Processor 550 may be any type of processor capable of executing instructions stored in memory 510 and capable of interfacing with the various components shown in FIG. 5. For example, processor 550 may be a microprocessor, a digital signal processor, an application specific processor, or the like. In some embodiments, processor 550 is a component within a larger integrated circuit such as a system on chip (SOC) application specific integrated circuit (ASIC).

Display controller 552 provides an interface between processor 550 and display device 150. In some embodiments, display controller 552 is integrated within processor 550, and in other embodiments, display controller 552 is integrated within display device 150.

Display device 150 is an output device capable of presenting information for visual, audible, or tactile reception. Examples include, but are not limited to, analog electronic displays, digital displays, monitor displays, and the like. Further, in some embodiments, display device 150 may include a touch sensitive surface, sensor, or set of sensors that accept input from a user. For example, display device 150 may detect when and where an object touches the screen, and may also detect movement of an object across the screen. When touch sensitive display device detects input, display controller 552 and processor 550 (in association with user interface component 521) may determine whether a gesture is to be recognized.

Display device 150 may be manufactured using any applicable display technologies, including for example, liquid crystal display (LCD), active matrix organic light emitting diode (AMOLED), and the like. Further, display device 150 may be manufactured using any application touch sensitive input technologies, including for example, capacitive and resistive touch screen technologies, as well as other proximity sensor technologies.

Cellular radio 560 may be any type of radio that can communicate within a cellular network. Examples include, but are not limited to, radios that communicate using orthogonal frequency division multiplexing (OFDM), code division multiple access (CDMA), time division multiple access (TDMA), and the like. Cellular radio 560 may operate at any frequency or combination of frequencies without departing from the scope of the present invention. In some embodiments, cellular radio 560 is omitted.

Bluetooth radio 554 is a type of non-near field radio capable of communicating on a frequency between 2.402 GHz and 2.480 GHz. Bluetooth is an example of a non-near-field protocol because the wavelength is on the order of 4.5 inches and the intended communication distance is typically much greater than 4.5 inches. The use of the term “non-near-field radio” is not meant to imply that the distance of communication cannot be less than the wavelength for the non-near-field radio. Bluetooth radio 554 is capable of communicating on a personal-area network (PAN) with other Bluetooth devices on the personal-area network. In some embodiments Bluetooth radio 554 is omitted.

Wi-Fi radio 556 is a wireless device capable of connecting to a wireless access point and allows for the connectivity on to a wireless network using IEEE 802.11 networking standards. In some embodiments Wi-Fi radio 556 is omitted.

Audio circuits 562 provide an interface between processor 550 and audio devices such as speaker 572 and microphone 574.

NFC radio 566 is a radio that provides near field communications capability to mobile device 500. In some embodiments, NFC radio 566 operates at 13.56 MHz, although this is not a limitation of the present invention.

Secure element 564 provides secure information storage. Secure element 564 stores identity data, including static data and dynamic data. In some embodiments, secure element 564 stores static data and determines new values for dynamic data each time it is requested. For example, in some embodiments, secure element 564 is configured to provide identity data when requested by the processor. The identity data requested may include static data that does not change each time the identity data is requested and/or dynamic data that does change each time the identity data is requested. Examples of static data include, but are not limited to, payment card account identification data such as a financial account card number. Examples of dynamic data include, but are not limited to, card security codes (CSC) such as a card verification value.

In some embodiments, secure element 564 and NFC radio 566 are separate devices as shown in FIG. 5, and in other embodiments, secure element 564 and NFC radio 566 are combined into a single integrated circuit. In still further embodiments, one or both of secure element 564 and NFC radio 566 are integrated into another semiconductor device such as processor 550.

Examples of smart card controllers that combine both secure element 564 and NFC radio 566 are the “SmartMX” controllers sold by NXP Semiconductors N.V. of Eindhoven, The Netherlands. In some embodiments, the secure element has an ISO/IEC 7816 compatible interface that communicates with other components within mobile device 500 (e.g., processor 550), although this is not a limitation of the present invention. Further, in some embodiments, the NFC radio has an ISO/IEC 14443 contactless interface.

Mobile device 500 may include a plurality of devices to transmit dynamic identity data. For example, display device 150 may display a visual indication of identity data, where the visual indication is one of a plurality of identity data transmission modes used.

In some embodiments secure element 564 may include a contact interface coupled to processor 550 and a contactless interface coupled to NFC radio 566. Furthermore, secure element 564 may be any type of secure element capable of providing a first sequence of dynamic data and a second sequence that differs from the first sequence.

Secure element 564 may also include any type of secure element capable of providing dynamic data to processor 550 over multiple requests forming a first sequence of dynamic data. In some embodiments, the first sequence of dynamic data may be unique to the identity data transmission mode corresponding to the display of a visual indication of identity data. For example, processor 550 may request identity data from secure element 564 multiple times to display a sequence of visual indications of identity data via display device 150. In response to each request, secure element 564 provides static and dynamic data, where the dynamic data forms a first sequence of dynamic data over the multiple requests. Processor 550 may also request identity data from secure element 564 to transmit the identity data via NFC radio 566, where the NFC radio is a second one of the plurality of identity transmission modes used by the plurality of devices included in mobile device 500. For example, processor 550 may request identity data from secure element 564 multiple times to transmit a sequence of identity data via NFC radio 566. In response to each request, secure element 564 provides static and dynamic data, where the dynamic data forms a second sequence of dynamic data over the multiple requests. Other examples of identity transmission modes used by the plurality of devices in mobile device 500 include, but are not limited to, transmission of identity data by speaker, Wi-Fi radio, Bluetooth radio, cellular telephone radio, and the like. In other embodiments, the sequence of dynamic data does not vary based on which of the plurality of identity data transmission modes is used to transmit identity data.

Mobile device 500 may also include many other circuits and services that are not specifically shown in FIG. 5. For example, in some embodiments, mobile device 500 may include a global positioning system (GPS) radio, haptic feedback devices, and the like. Any number and/or type of circuits and services may be included within mobile device 500 without departing from the scope of the present invention.

Memory 510 may include any type of memory device. For example, memory 510 may include volatile memory such as static random access memory (SRAM), or nonvolatile memory such as FLASH memory. Memory 510 is encoded with (or has stored therein) one or more software modules (or sets of instructions), that when accessed by processor 550, result in processor 550 performing various functions. In some embodiments, the software modules stored in memory 510 may include an operating system (OS) 520 and applications 530. Applications 530 may include any number or type of applications. Examples provided in FIG. 5 include a telephone application 531, a contacts application 532, a music player application 533, a mobile payment application (Bank 12 Credit Card) 534, a mobile banking application (Bank 42 Mobile Banking) 535, and an email application 536. Memory 510 may also include any amount of space dedicated to data storage 540.

In some embodiments, one or more of applications 530 may cause processor 550 to request identity data from secure element 564, and to display the identity data as a visual indication on the display device 150. The identity data may include static and dynamic data, where the dynamic data forms a sequence of dynamic data over multiple requests. The sequence of dynamic data may be unique to the transmission mode corresponding to a visual indication on display device 150, or may be common with one or more other transmission modes. In other embodiments, one or more of applications 530 may cause processor 550 to request identity data from secure element 564, and to represent the identity data with dynamic audio and/or over a radio link.

In some embodiments, there are multiple sequences of dynamic data. For example, a first sequence of dynamic data provided to processor 550 for visual display may differ from a second sequence of dynamic data provided to NFC radio 566 to be transmitted over a radio link. In other embodiments, the dynamic data provided to processor 550 and the dynamic data provided to NFC radio 566 are part of a common sequence of dynamic data. Processor 550 and NFC radio 566 represent two of many possible identity data transmission modes. Any number of identity data transmission modes may be utilized, and sequences of dynamic data may be common to each of the data transmission modes or may be unique to each of the transmission modes.

Operating system 520 may be a mobile device operating system such as an operating system to control a mobile phone, smartphone, tablet computer, laptop computer, or the like. As shown in FIG. 5, operating system 520 includes a user interface component 521. Operating system 520 may include many other components without departing from the scope of the present invention.

User interface component 521 includes processor instructions that cause mobile device 500 to display desktop screens, recognize gestures, and provide navigation between desktop screens. User interface 521 also includes instructions to display menus, move icons, and manage other portions of the display environment.

Telephone application 531 may be an application that controls a cell phone radio. Contacts application 532 includes software that organizes contact information. Contacts application 532 may communicate with telephone application 531 to facilitate phone calls to contacts. Music player application 533 may be a software application that plays music files that are stored in data store 540.

Credit card application 534 may be a software application that transmits identity data for the purpose of effecting a credit card transaction. When credit card application 534 is running on processor 550, processor 550 may request identity data from secure element 564 for communicating to a point of sale. Communication of the identity data may occur using any transmission mode, including a visual indication on display device 150, an audio indication using audio circuits 562 and speaker 572, or using any of the radio links available to mobile device 500. Credit card application 534 may be a downloaded “thick” application, or may be a “thin” application that uses Internet browser functionality.

Mobile banking application 535 may be a software application that communicates with a banking service to allow a user to perform banking functions such as balance inquiries, funds transfers, bill payment and the like. When mobile banking application 535 is running on processor 550, processor 550 may request identity data from secure element 564 for communication outside of mobile device 500. One example is a debit card corresponding to an account accessible by mobile banking application 535. Communication of the identity data may occur using any transmission mode, including a visual indication on display device 150, an audio indication using audio circuits 562 and speaker 572, or using any of the radio links available to mobile device 500. Mobile banking application 535 may be a downloaded “thick” application, or may be a “thin” application that uses Internet browser functionality.

Although FIG. 5 shows mobile financial applications, it is to be understood that other types and variations of applications may be resorted to without departing from the spirit and scope of the invention. For example, other applications may include applications that store and retrieve identities such as a passport and/or user identification. In other embodiments, applications may include granting access to a building and/or secure space.

Each of the above-identified applications corresponds to a set of instructions for performing one or more functions described above. These applications (sets of instructions) need not be implemented as separate software programs, procedures or modules, and thus various subsets of these applications may be combined or otherwise re-arranged in various embodiments. For example, telephone application 531 may be combined with contacts application 532. Furthermore, memory 510 may store additional applications (e.g., video players, camera applications, etc.) and data structures not described above.

It should be noted that device 500 is presented as an example of a mobile device, and that device 500 may have more or fewer components than shown, may combine two or more components, or may have a different configuration or arrangement of components. For example, mobile device 500 may include many more components such as sensors (optical, touch, proximity etc.), or any other components suitable for use in a mobile device.

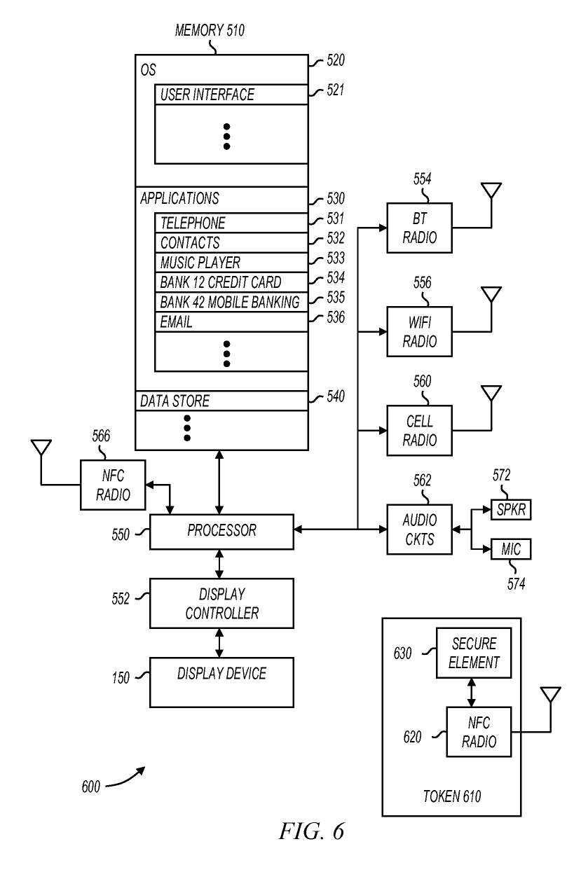

FIG. 6 shows a block diagram of a mobile device and a token in accordance with various embodiments of the present invention. Mobile device 600 represents any type of mobile device capable of performing as described herein, including any of mobile devices 100 (FIGS. 1-4). For example, in some embodiments, mobile device 600 may be a cell phone, a smartphone, a tablet computer, a laptop computer, or the like. Token 610 is a hardware device that includes secure element 630 and NFC radio 620. Token 610 may take any form factor. Examples include, but are not limited to, security tokens, key fobs, key chains, and the like.

In operation, NFC radio 620 and NFC radio 566 are capable of communicating with each other, thereby providing communications between mobile device 600 and token 610. Processor 550 requests identity data from secure element 630 across the radio link between NFC radios 566, 620. Secure element 630 responds by providing identity data that includes both static and dynamic data, where the sequence of dynamic data may be a function of the identity data transmission mode.

In some embodiments, secure element 630 provides different sequences of dynamic data based on the transmission mode used to transmit identity data. For example, secure element 630 may provide a first sequence of dynamic data unique to processor 550 transmitting identity data by display device 150. Secure element 630 may also provide a second sequence of dynamic data unique to processor 550 transmitting identity data by Bluetooth radio 554; however this is not a limitation of the present invention. In some embodiments, Bluetooth radio 554 may be any one of a plurality of identity data transmission modes used by a plurality of devices, such as Wi-Fi radio 556, cellular radio 560, audio circuits 562, and the like.

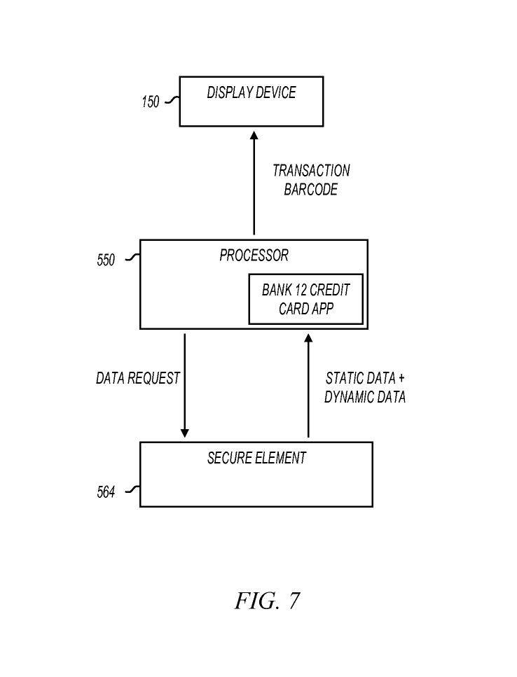

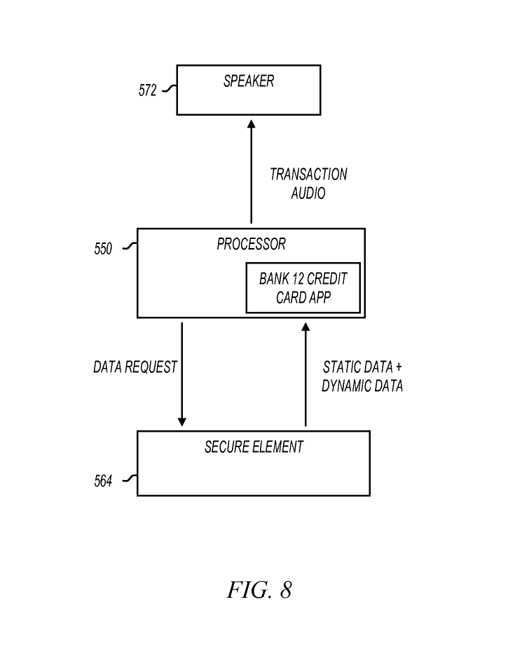

FIGS. 7 and 8 show interactions between a processor, a secure element, and a display device in accordance with various embodiments of the present invention. When an application (e.g., Bank 12 Credit Card application 534) is executed, it causes processor 550 to request identity data from secure element 564. Processor 550 may make the data request using any industry standard protocol, for example, ISO/IEC 7816. Secure element 564 determines whether the application has permission to access the requested data. If secure element 564 determines that the application has authorization to access the requested data, secure element 564 provides identity data to processor 550. The identity data provided includes both static and dynamic data.

In FIG. 7 processor 550 generates a transaction barcode that includes the identity data acquired from secure element 564. Processor 550 then provides the transaction barcode to display device 150. In FIG. 8 processor 550 generates a transaction audio that includes the identity data acquired from secure element 564. Processor 550 then provides the transaction audio to speaker device 572.

In some embodiments, the dynamic data is generated by secure element 564 each time identity data is requested. For example, the dynamic data may include three components: a counter value, a random starting value, and a second random value. Furthermore, the current dynamic data may be comprised of a random starting value plus a counter value multiplied by a second random value.

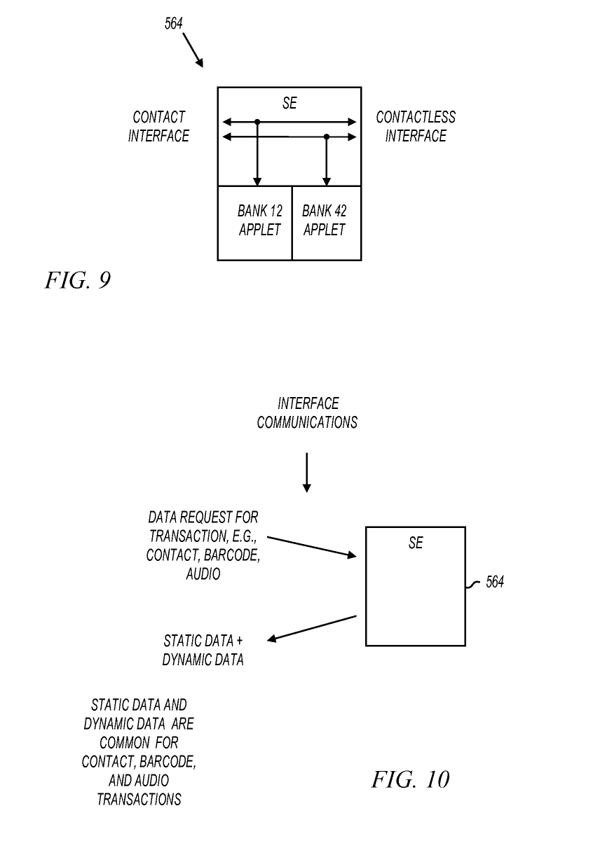

FIG. 9 shows a secure element in accordance with various embodiments of the present invention. Secure element 564 includes a contact interface as well as a contactless interface. The contact interface may be physically connected to other hardware devices. Example devices that may be coupled to the contact interface include, but are not limited to, memory cards, iOS connectors, integrated processors, and the like. The contactless interface is comprised of wireless connected devices. Examples of contactless interface include, but are not limited to, NFC radios, Bluetooth radios, smartcards, and the like. Secure element 564 is capable of running various security applets (e.g., Bank 12 applet and Bank 42 applet shown). Security applets perform security computations and communicate information using either contact interface or contactless interface, or any combination thereof. The entire security applet, or some user specific parameters of the security applet such as identity information (e.g. credit card account details as well as parameters that determine the static and dynamic data associated with the account) or some aspects of the identity information (e.g. parameters that determine dynamic data associated with a credit card account) may be programmed into the secure element over a network such as wired or wireless network including but not limited to cellular, Wi-Fi, and Bluetooth.

Parameters for dynamic data that maybe programmed over a network such as the internet may include a starting random value, a random increment value, and a counter. In some embodiments, the dynamic data is determined as the sum of the starting value added to the counter multiplied the random increment value. When a dynamic data is presented and the transaction is considered successful, the counter value is incremented. The identity issuer such as a bank will know these random values and will have a sense of the transaction counter and therefore will be able to validate if the dynamic data presented is for a particular user. The static and dynamic data separately or in combination can be generated locally and presented using one of plurality of devices such as NFC radio, visual or audio available within the mobile device.

In some embodiments, the set of parameters for dynamic data is uniquely different sets for each of the plurality of devices such as NFC radio, visual or audio. When generating dynamic data using the different sets of parameters, different sequences of dynamic data will be generated based on which one of the plurality of devices is used for transmitting.

The set of parameters for dynamic data explained above are presented as an example. Other parameters may be used to generate dynamic data and unique sequences of dynamic data.

The over the network programming event as expected requires access to a network such as the internet. However after this one-time programming event for an account, since the security applet for the account and the identity information for the security applet associated with the account are stored in the secure element readily accessible by a legitimate user on a device such as a mobile device, the presentation of identity data (static or static in combination with dynamic) to be presented as visual or audio or NFC radio representation for transaction purposes will be accessed locally or in proximity to the device and not remotely via internet network connection.

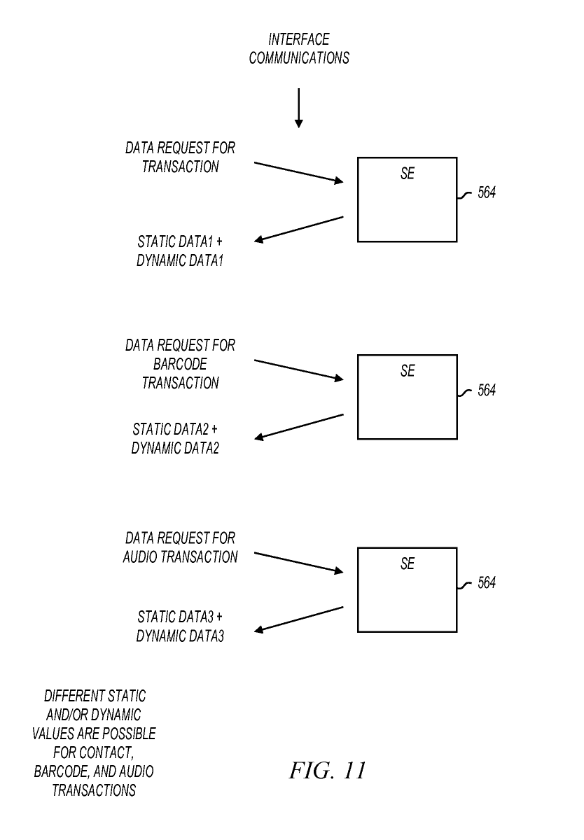

FIGS. 10 and 11 show interface communications with a secure element in accordance with various embodiments of the present invention. FIG. 10 includes secure element 564 and shows a data request over interface communications for a transaction. The transaction may include, contact transaction, barcode transaction, and/or audio transaction. In some embodiments the data request may be for a contactless transaction. In response to the data request secure element 564 provides identity data that includes static and dynamic data.

FIG. 11 shows secure element 564 capable of providing different static and dynamic values. Examples include, but are not limited to, identity data provided in response to a data request for transaction, identity data provided in response to a data request for a barcode transaction, and identity data provided in response to a data request for audio transaction. Secure element 564 may be capable of providing many other values of static and dynamic data in response to data requests that are not specifically shown in FIG. 11. For example, in some embodiments, secure element 564 may be capable of providing different static and dynamic values in response to NFC transaction requests, Bluetooth transaction requests, and the like. Any number and/or type of identity data responses may be provided by secure element 564 without departing from the scope of the present invention.

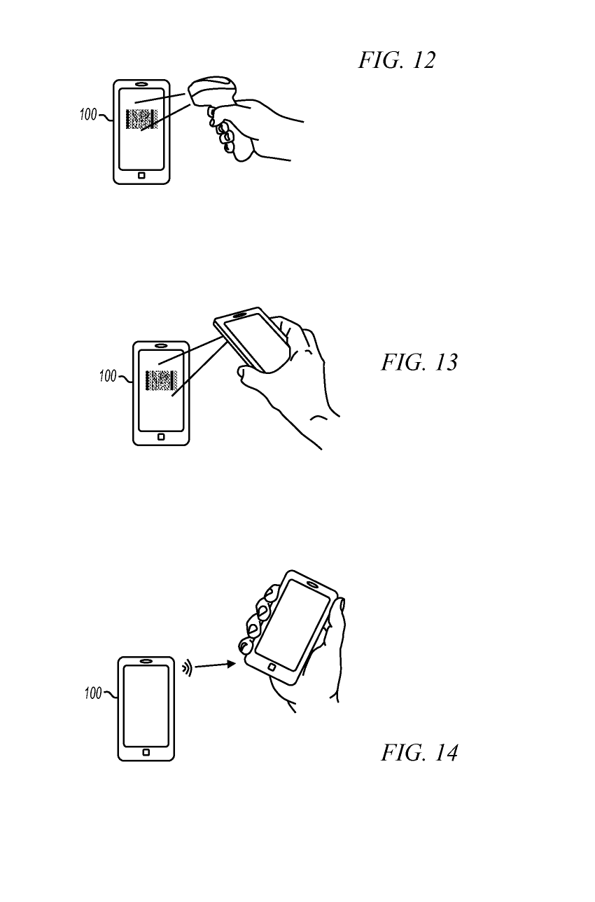

FIGS. 12 and 13 show various devices interacting with a dynamic identity representation in accordance with various embodiments of the present invention. FIG. 12 shows a barcode reader interacting with a dynamic identity representation displayed by mobile device 100; however this is not to be taken in a limiting sense. Barcode reader device may be any device capable of interacting with visual displays, for example, a point of sale scanner, a mobile device with a camera, or a scanner to authorize entry into a building, room, or secure space. In some embodiments, the application involved with the dynamic identity representation can be an access application.

FIG. 13 shows a mobile device camera interacting with a dynamic identity representation in accordance with various embodiments of the present invention. The interaction shown in FIG. 13 between mobile 100 and the mobile device camera is not to be taken in a limiting sense and is shown to represent a use case.

FIG. 14 shows a mobile device microphone interacting with a dynamic identity representation in accordance with various embodiments of the present invention. Mobile device 100 is shown providing a dynamic identity representation in audio format.

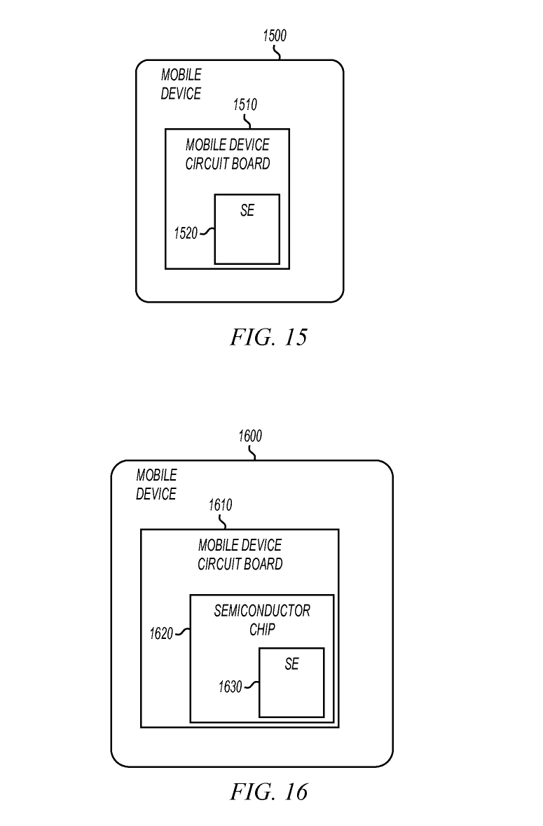

FIG. 15 shows a mobile device with a secure element on a circuit board in accordance with various embodiments of the present invention. Mobile device 1500 includes circuit board 1510, which in turn includes secure element (SE) 1520. Circuit board 1510 may include a processor, memory, or circuits that support other services. In some embodiments, circuit board 1510 is a board that is fixed within mobile device 1500 and that includes many components other than those shown.

In some embodiments, SE 1520 resides in an add-on slot on the circuit board, and may be removable or nonremovable. For example, in some embodiments, an add-on slot may be provided on circuit board 1510 to accept SE 1520. In some of these embodiments, SE 1520 may be user accessible and removable, and in other embodiments, SE 1520 may be nonremovable even though it resides in an add-on slot.

FIG. 16 shows a mobile device with a secure element in a semiconductor chip in accordance with various embodiments of the present invention. Mobile device 1600 includes circuit board 1610, which in turn includes semiconductor chip 1620. Semiconductor chip also includes SE 1630. In some embodiments, the semiconductor chip includes other functionality such as a microprocessor. In these embodiments, SE 1630 is embedded within the semiconductor chip 1620. Circuit board 1610 includes circuits that provide one or more services. For example, circuit board 1610 may include a memory, a display controller, a cellular radio, or the like. In some embodiments, circuit board 1610 is a board that is fixed within mobile device 1600 and that includes many components other than those shown.

In some embodiments, SE 1630 resides in an add-on slot in the semiconductor chip, and the semiconductor chip resides in an add-on slot on the circuit board, and both may be removable or non-removable.

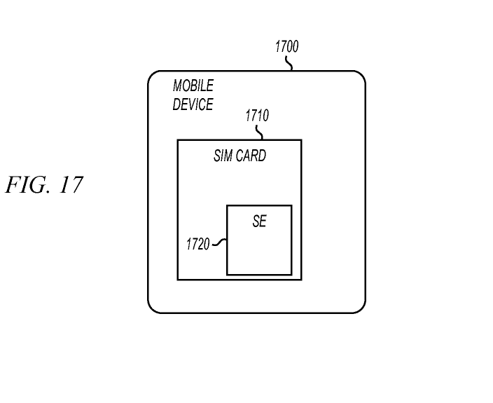

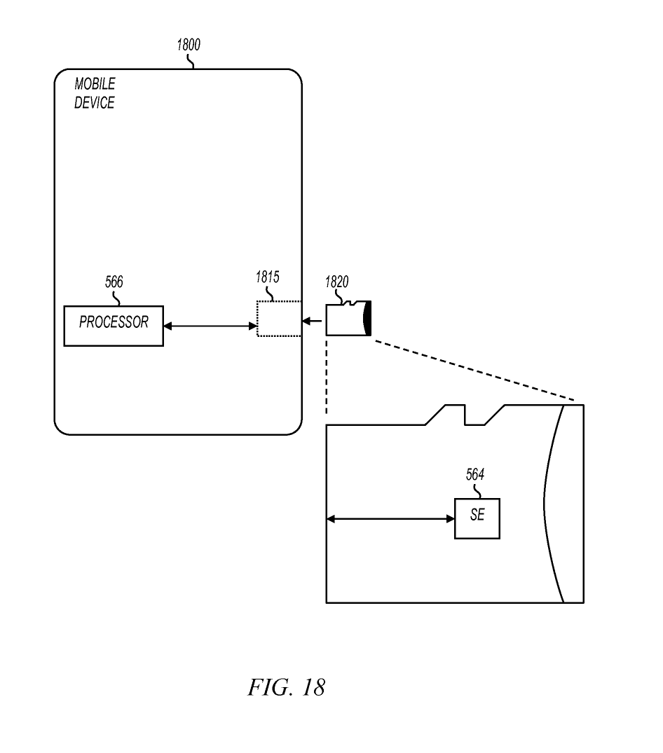

FIG. 17 shows a mobile device with a secure element on a subscriber identity module (SIM) card in accordance with various embodiments of the present invention. Mobile device 1700 includes subscriber identity module (SIM) 1710, which in turn includes secure element (SE) 1720. SIM 1710 includes circuits that provide one or more services. For example, SIM 1710 may include other circuits that identify a user of mobile device 1700 to a mobile network operator. In some embodiments, SIM card 1710 is a removable card that is inserted into an add-on slot within mobile device 1700 and that includes many components other than those shown. In some embodiments, SIM card 1710 may be added to a non-removable add-on slot.

FIG. 18 shows a mobile device with a memory card that includes a secure element in accordance with various embodiments of the present invention. Mobile device 1800 includes processor 566 and add-on slot 1815. Add-on slot 1815 accepts memory card 1820, which is shown as a microSD memory card; however this is not a limitation of the present invention. In some embodiments, microSD memory card 1820 may be added to a non-removable add-on slot. For example, system memory for mobile device 1800 may be provided by memory card 1820, and memory card may be placed in an add-on slot in such a manner that it is nonremovable. Memory card 1820 includes secure element 564. The combination of mobile device 1800 and memory card 1820 is an example of an electronic system that includes a mobile device and an add-on card that includes a secure element.

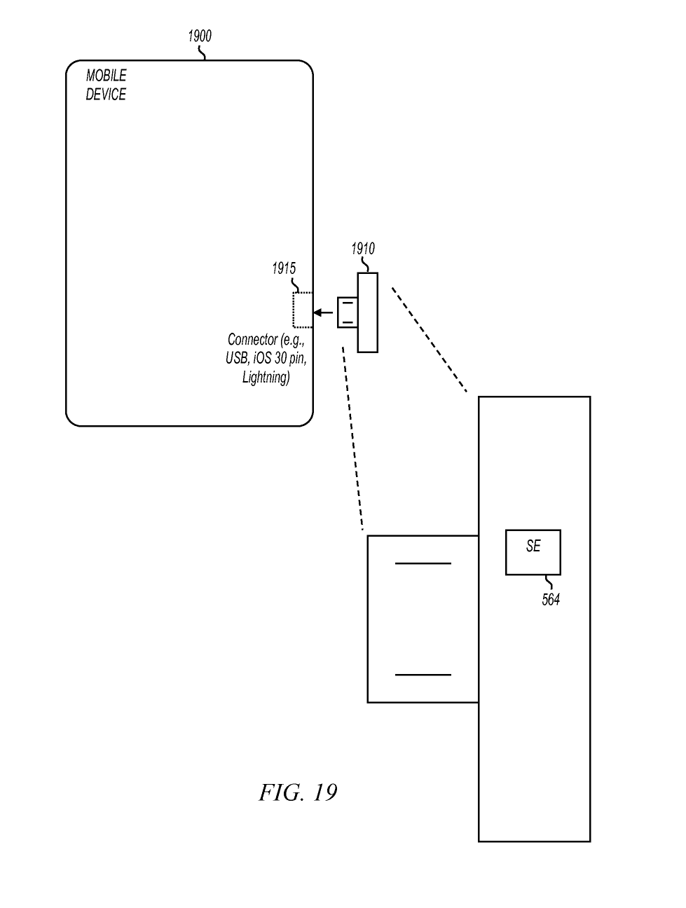

FIG. 19 shows a mobile device with a connector that includes a secure element in accordance with various embodiments of the present invention. Mobile device 1900 includes add-on slot 1915. Add-on slot 1915 is shown as a connector port which accepts connector 1910; however this is not a limitation of the present invention. Add-on slot 1915 may any type of connector port capable of performing as described. For example, add-on slot 1915 may be a universal serial bus (USB) connector port, an iOS 30 pin connector port, a Lightning connector port, or the like. Connector 1910 may be any type of connector capable of performing as described. For example, connector 1910 may be a universal serial bus (USB) connector, an iOS 30 pin connector, a Lightning connector, or the like. Connector 1910 includes secure element 564. The combination of mobile device 1900 and connector 1910 is an example of an electronic system that includes a mobile device and a connector that includes a secure element. In some embodiments, connector device 1910 may be added to a non-removable add-on slot 1915.

In some embodiments the device with the SE may not be physically present in an add-on slot. It may be coupled via any combination of electric, magnetic, and optical means such as Bluetooth, NFC, infrared.

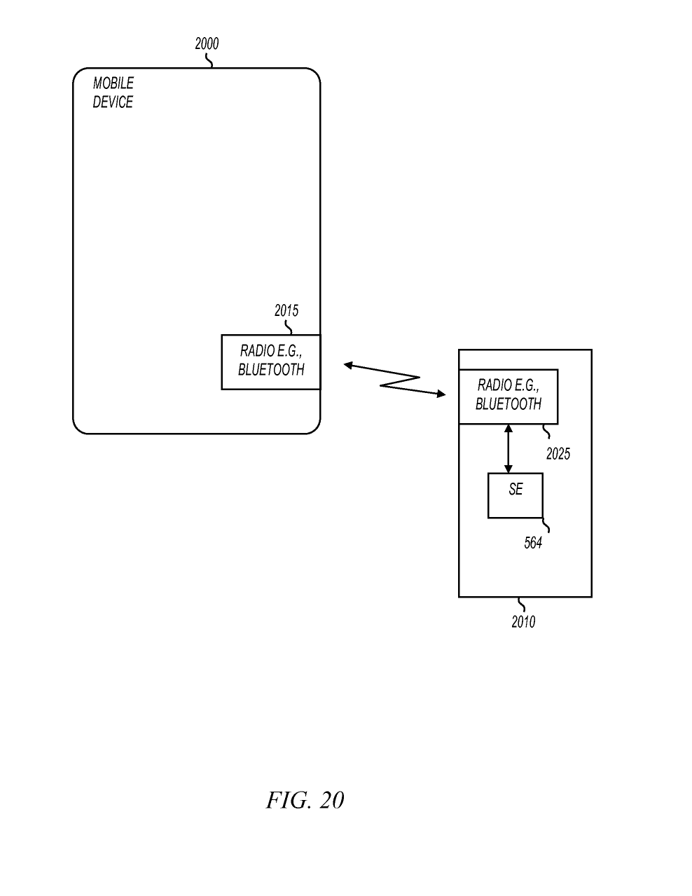

FIG. 20 shows a mobile device with a token that includes a secure element in accordance with various embodiments of the present invention. Mobile device 2000 includes radio 2015. Radio 2015 is shown as a Bluetooth radio; however this is not a limitation of the present invention. FIG. 20 shows token 2010, which includes Bluetooth radio 2025 and secure element 564. Bluetooth radio 2015 in mobile device 2000 communicates with Bluetooth radio 2025 in token 2010 to request and receive dynamic entity representation from secure element 564. Bluetooth radio 2025 in token 2010 communicates with secure element 564 to acquire the dynamic identity representation from secure element 564. Although FIG. 20 shows Bluetooth radio 2010, it is not meant to limit the scope of the invention.

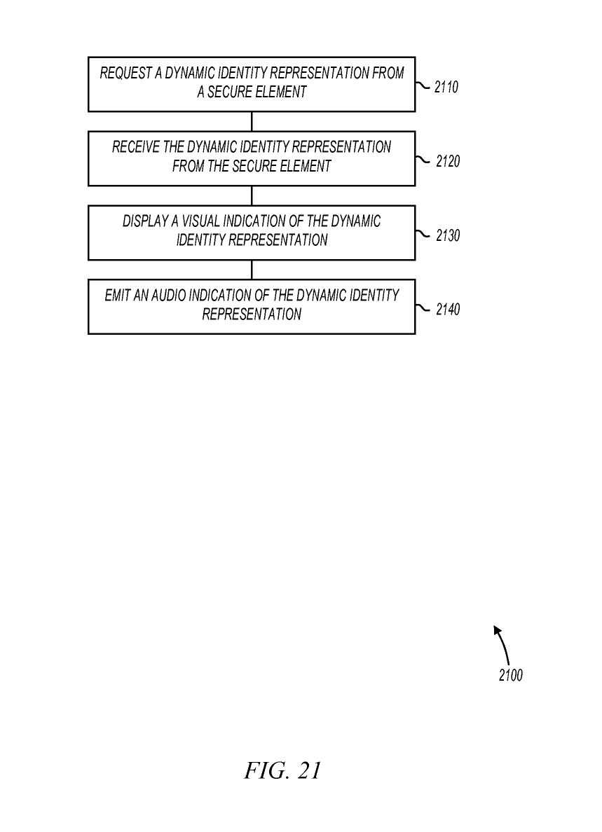

FIG. 21 shows a flowchart of methods in accordance with various embodiments of the present invention. In some embodiments, method 2100 may be performed by a mobile device such as any of mobile devices 100, 1500, 1600, 1700, 1800, 1900, or 2000. Further, in some embodiments, method 2100 may be performed by a processor that is executing software such as user interface component 521. Method 2100 is not limited by the type of system or entity that performs the method. The various actions in method 2100 may be performed in the order presented, in a different order, or simultaneously. Further, in some embodiments, some actions listed in FIG. 21 are omitted from method 2100.

Method 2100 begins at 2110 in which a request for a dynamic identity representation from a secure element is made. In some embodiments, the request is made via contact interface. For example, a mobile device with a circuit board that includes a secure element. In other embodiments, the request is made via contactless interface. For example, a mobile device that includes an NFC radio capable of communicating with a secure element not included in the mobile device.

At 2120, dynamic identity representation is received from a secure element. The receipt of the dynamic identity representation may be by contact or contactless interface, or any combination thereof. In some embodiments, the request is made via contact interface. For example, a mobile device with a circuit board that includes a secure element. In other embodiments, the request is made via contactless interface. For example, a mobile device that includes an NFC radio capable of communicating with a secure element not included in the mobile device.

At 2130, a visual indication of the dynamic identity representation is displayed. At 2140 an audio indication of the dynamic identity representation is emitted.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

What is claimed is:

1. A mobile device comprising:
a display device;
a processor;
a secure element coupled to the processor, the secure element configured to provide identity data when requested by the processor, the identity data including static data that does not change each time the identity data is requested, and dynamic data that does change each time the identity data is requested; and
a memory device coupled to the processor, the memory device including an application that when executed by the processor causes the processor to request the identity data from the secure element, and to display the identity data as a visual indication on the display device.

2. The mobile device of claim 1 wherein the visual indication comprises a barcode.

3. The mobile device of claim 1 wherein the static data comprises payment card account identification data.

4. The mobile device of claim 1 wherein the dynamic data comprises payment card account verification data.

5. The mobile device of claim 1 further comprising:
a speaker coupled to the processor;
wherein the application further causes the processor to request identity data from the secure element to be transmitted by the speaker; and
wherein a sequence of dynamic data provided to the processor for display differs from a sequence of dynamic data provided to the processor for transmission via the speaker.

6. The mobile device of claim 1 further comprising:
a speaker coupled to the processor;
wherein the application further causes the processor to request identity data from the secure element to be transmitted by the speaker; and
wherein the dynamic data provided to the processor for display and dynamic data provided to the processor for transmission via the speaker are part of a common sequence of dynamic data.

7. A mobile device comprising:
a plurality of devices to transmit identity data, wherein the plurality of devices includes a display device to display a visual indication of identity data, the display of the visual indication of identity data being one of a plurality of identity data transmission modes used by the plurality of devices;
a processor; and
a secure element configured to provide the identity data when requested by the processor, the identity data including static data and dynamic data, wherein the dynamic data provided to the processor over multiple requests forms a first sequence of dynamic data;
wherein the first sequence of dynamic data is unique to the identity data transmission mode corresponding to the display of the visual indication of identity data.

8. The mobile device of claim 7 wherein the dynamic data comprises payment card account verification data.

9. The mobile device of claim 7 wherein the visual indication comprises a barcode.

10. The mobile device of claim 7 wherein the plurality of devices comprises a near field communications (NFC) radio, wherein transmission of identity data by the NFC radio is a second one of the plurality of identity data transmission modes.

11. The mobile device of claim 7 wherein the plurality of devices comprises a speaker, wherein transmission of identity data by the speaker is a second one of the plurality of identity data transmission modes.

12. The mobile device of claim 7 wherein the plurality of devices comprises a Wi-Fi radio, wherein transmission of identity data by the Wi-Fi radio is a second one of the plurality of identity data transmission modes.

13. The mobile device of claim 7 wherein the plurality of devices comprises a bluetooth radio, wherein transmission of identity data by the bluetooth radio is a second one of the plurality of identity data transmission modes.

14. The mobile device of claim 7 wherein the plurality of devices comprises a cellular telephone radio, wherein transmission of identity data by the cellular telephone radio is a second one of the plurality of identity data transmission modes.

15. A mobile device comprising:
a plurality of devices to transmit identity data, wherein the plurality of devices includes a display device to display a visual indication of identity data, the display of the visual indication of identity data being one of a plurality of identity data transmission modes used by the plurality of devices; and
a secure element configured to provide identity data when requested, the identity data including static data and dynamic data, wherein the dynamic data provided over multiple requests forms a sequence of dynamic data;
wherein the sequence of dynamic data does not vary based on which of the plurality of identity data transmission modes is used to transmit identity data.

16. A method comprising:
requesting identity data from a secure element;
receiving from the secure element identity data that includes static data that does not change for each request of identity data and dynamic data that does change for each request of identity data;
generating a visual indication of the identity data; and
displaying the visual indication on a display screen of a mobile device.

17. The method of claim 16 wherein the dynamic data is generated by the secure element each time identity data is requested.

18. The method of claim 16 wherein the static data comprises payment card account identification data.

19. The method of claim 16 wherein the dynamic data comprises payment card account verification data.

20. The method of claim 16 wherein the visual indication comprises a barcode.
